(19) United States
(12) Patent Application Publication
(10) Pub. No.: US 2004/0083036 A1
(43) Pub. Date: Apr. 29, 2004

(54) Method for the prioritized processing of information

(76) Inventor: Alfons Ziegler, Maerwil (CH)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/684,382

(22) Filed: Oct. 15, 2003

Related U.S. Application Data
(63) Continuation of application No. PCT/EP02/01589, filed on Feb. 14, 2002.

(30) Foreign Application Priority Data
Apr. 24, 2001 (EP) 01 109 969.4

(51) Int. Cl. G06F 17/00; G06F 7/00; G05D 3/00; G05D 1/00

(52) U.S. Cl. 701/1

(57) ABSTRACT

A method for the prioritized processing of information is disclosed. The information is transmitted in a wireless communication between central and peripheral units of a traffic control system, whereby first information units is transmitted from at least one central unit of a traffic control system, and communication between individual peripheral units may be established for second information units. On communication between the individual peripheral units, a second information unit is processed as a priority, if the above has previously received a keycode, transmitted with the first information unit and the above corresponds to a keycode, transmitted with the second information unit. By means of the above prioritized information processing, the display content of display units may, for example, be maintained up to date, directly on the departure of a bus.

### CROSS REFERENCE TO RELATED APPLICATIONS

The present application is a continuation of international application PCT/EP02/01589, filed Feb. 14, 2002 and which designated the United States, and claims priority to European application 01109969.4, filed Apr. 24, 2001, the both of which are herein incorporated by reference.

### BACKGROUND OF THE INVENTION

The invention relates to a method for the prioritized processing of information in accordance with the precharacterizing clause of patent claim 1.

In EP 0 797 818 B1 a procedure is given for wireless communication between central and peripheral units, particularly for a traffic control system, that on one hand enables bi-directional communication between the aforementioned and on the other hand enables direct communication in the near area between individual peripheral units, such as between the buses or between a bus and a fixed unit, e.g. traffic light system. This enables the optimum use of the scarce frequency resource.

With increasing traffic density and the installation of additional services, such as situation-dependent passenger information systems, the few allocatable radio channels have been shown to be bottlenecks with regard to the communication of information to be processed according to priority.

EP 0 952 565 A2 describes a vehicle communication system and a method for dynamic allocation of channels that uses distributed base stations to enable communication between a number of vehicles and a central station.

The disadvantage is the cost of setting up the base stations and the high complexity of the proposed solution.

### SUMMARY OF THE INVENTION

An object of this invention is therefore to provide a method that, while retaining the known infrastructure, enables the prioritized processing of information particularly for a traffic control system, without impairing the flow of information.

Furthermore, it should be possible to output such information to be processed according to priority from authorized peripheral units only.

The object is achieved by the measures given in patent claim 1. Advantageous embodiments of the invention are given in further claims.

By means of the steps given in patent claim 1, a peripheral unit can correctly process, without a delay, an information unit directly received from a different peripheral unit, without a central unit being involved in this communication. This makes sure the indication of the departure of a bus on the display unit is cancelled directly on the departure of the particular bus and passengers arriving only very slightly late at the bus stop receive no false information that the bus has apparently yet to arrive.

This can also produce the following additional advantages:

i) Because the individual peripheral units (11,15) communicate with each other using a different frequency from the frequency used for communication between at least one central unit (11) and the peripheral units (12,15), the transmission capacity is not adversely affected during the communication between at least one central unit and the peripheral units. (Patent claim 2).

ii) Because the individual peripheral units (11,15) communicate with each other using the same frequency as used for communication between at least one central unit (11) and the peripheral units (12,15) but the transmitter power for communication between the individual peripheral units is reduced to an extent that the range is limited to the immediate environment of a peripheral unit, no other infrastructure needs to be installed for communication between the peripheral units and the transmission capacity is thus not adversely affected during the communication between at least one central unit and the peripheral units (patent claim 4).

iv) Because the second information unit (INF2) contains a field (COMMAND2) that specifies the type of prioritized processing, it is possible to specify the type of prioritized processing directly from an operating status in the receiving and/or transmitting peripheral unit (patent claim 5).

### BRIEF DESCRIPTION OF THE SEVERAL VIEWS OF THE DRAWINGS

The invention is explained in more detail using drawings as examples. These are as follows.

FIG. 1 Overview of the communication relationships between a central unit and peripheral units.

FIG. 2 Overview of system for implementing the method in accordance with the invention.

### DETAILED DESCRIPTION OF THE INVENTION

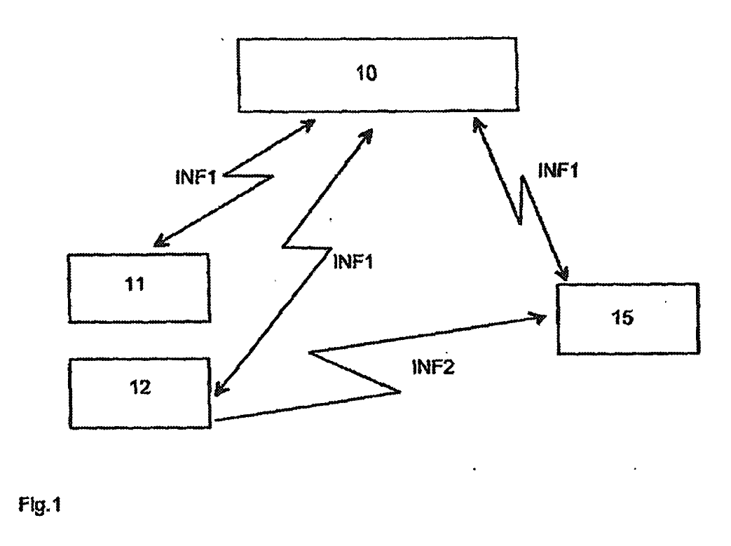

FIG. 1 shows at least one central unit 10 that functions as a control center of a traffic system and peripheral units 11 and 12 each of which is allocated to an omnibus, referred to in the following as bus. Furthermore, a further peripheral unit 15 is shown as a display unit at a bus stop.

Communication between the central unit 10 and the peripheral units 11, 12 and 15 takes place using the multiplexing method, with each peripheral unit being allocated a time slot. Additionally, a time slot can be provided that, as a broadcast channel, is commonly available to all communication participants, i.e. all peripheral units 11, 12 and 15 and at least one central unit 10. Information units INF1 are communicated to the peripheral units from the central unit 10. Such information units INF1 are also known as telegrams. An example of the structure of an information unit INF1 of this kind is shown in the following table 1.

TABLE 1

| Name | Content, examples |
|---|---|
| . . . | |
| DESCRIPTOR | Description of the structure |
| | of the information content |
| INFO11 | Display content part 1 |
| INFO12 | Display content part 2 |
| KEYCODE 1 | Key code 1 |
| KEYCODE 2 | Key code 2 |
| . . . | |

The structure of the first information unit INF1 is given in the DESCRIPTOR field, in particular which fields are contained therein and details of the length of this information unit. This presentation shown in table 1 assumes that such an information unit INF1 is communicated to a display unit 15 on the basis of reported local information regarding a bus 11. The display content is contained in fields INFO11, and perhaps also additionally in a further field INFO12. For example, the sequence of characters 31;15.32; Schlieren” is shown in field INFO11. In this case “;” is a separator that separates the content. This display content is shown on display unit 15 itself as indicated in table 2.

TABLE 2

| Line | Departure | Direction |
|---|---|---|
| 31 | 15.32 | Schlieren |

Together with display content INFO11, an associated key code KEYCODE1 is also transmitted and is buffer stored in the control section of the display unit 15.

An information unit INF1 with a structure comparable to that in table 1 is also transmitted from the central control unit 10, e.g. on the basis of reported local information concerning a bus, and is buffer stored in an on-board computer on the bus. In particular, information unit INF1 to a bus contains the identical key code KEYCODE1 that was communicated to a display unit, and also the course number in a field COURSE. The key code KEYCODE1 can, for example, be formed from the vehicle number.

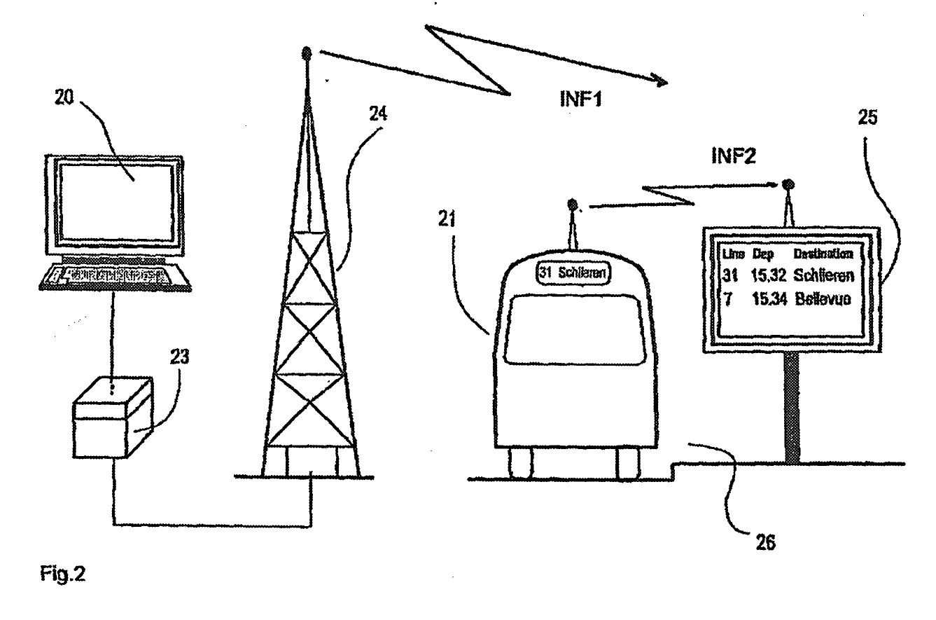

From the peripheral unit 11 in bus 21, see FIG. 2, a second information unit INF2 is communicated as shown in table 3.

TABLE 3

| Name | Content, examples |
|---|---|
| KEYCODE2 | Vehicle number |
| COMMAND2 | Action, instruction, e.g. delete |

In the field COMMAND2 there can be an instruction, for example, to delete the relevant line in the display unit. If when the second information unit INF2 is received the control section of the display unit 15 detects that the key code KEYCODE2 transmitted in it is identical to the key code KEYCODE1 transmitted previously, the content of the field COMMAND2 is executed by the control section. This is possible due to the allocation of KEYCODE1 to INFO11, that has resulted in accordance with the transmission of the first information unit INF1. The second information unit INF2 can have a fixed structure, or in the case of the first information unit INF1 a variable structure. If a variable structure is present, a field DESCRIPTOR2 is additionally provided. The unidirectional communication link shown in FIG. 1 can also be of a bi-directional kind.

FIG. 2 shows a system overview in which the implementation of the method in accordance with the invention is explained in more detail. A bus stop 26 has at least one display unit 25 on which the imminent departures of buses are shown. One bus 21 has arrived at a bus stop 26. A control center is formed from at least one operator station 20 and a computer system 23, together with radio transmission equipment including at least one antenna mast 24 that provides radio coverage for one zone of a local traffic operator. It is assumed that a first information unit INF1 has already been transmitted and the key code KEYCODE1 contained in it was buffer stored in the on-board computer. The driver locks the doors immediately before departing. The actuation of the door locking signals the on-board computer to pack the key code KEYCODE1 including a command COMMAND2 in a second information unit INF2, see table 3, and to transmit it in a time slot provided in the radio transmission interface. This information unit INF2 is received by the control section of display unit 25 and a comparison is carried out to determine whether a key code KEYCODE1 has been previously stored and whether it agrees with the transmitted key code KEYCODE2. If they agree, the display “31 15.32 Schlieren” is deleted because of the content of the field COMMAND2.

The method in accordance with the invention can also be used for the arrival of a bus at a bus station. For this purpose, the instruction “flashing” is provided in the field COMMAND2. If the aforementioned conditions are complied with on receipt of the second information unit INF2 in the control section of the display unit 25, the content of the field COMMAND2 has the effect that the departure time information “15.32” is hidden as shown in the illustration in FIG. 2 and the information Line and Destination is shown flashing. In this way, the passengers in the area of the bus station are made aware of the immediate departure of the relevant bus.

In the first information unit INF1, it can also be provided in the key code KEYCODE1, or additionally, that details of the validity or life of the key code be included. For example, that the key code is used up when it has been used once or if a particular command COMMAND2 is used and has no effect in the receiving peripheral unit if transmitted again by means of a further second information unit INF2.

The method in accordance with the invention is not confined to communication between a bus 21 and a display unit 25. A particularly advantageous application is the decentralized backup link that is merely initiated by the control center, i.e. by transmission of a first information unit INF1 to both buses, usually a shuttle vehicle. To back up the link, both buses in the area of the bus stop can communicate directly via second information units INF2, to ensure a connection for the passengers. A suitable display on a control unit allocated to the on-board computer can be used in this case to assist the driver.

A further use of the method in accordance with the invention is the arrival of buses in a depot. Possible actions in this case are instructions for special vehicle maintenance or the loading data to the on-board computer from a mass storage unit.

For the wireless transmission of the second information unit INF2, distances in the bus stop area of from a few meters up to a approximately 100 m are to be traveled. In an advantageous further development of the inventive method, it can be provided that this transmission takes place, for example, in a broadcast channel and thus reduces the transmitter power to an extent that a minimum reception field strength is ensured in the aforementioned bus stop area. In an alternative configuration, a different frequency can also be used and if need be a transmission method standardized for such purposes can also be used. The Bluetooth technology is particularly suitable for the immediate bus stop area. It is also possible to transmit in the infrared range.

The use of the method in accordance with the invention is not limited to communication for the local traffic area. This method can be used anywhere where a direct temporary communication is necessary between peripheral units, but this communication should if possible take place without direct control through a central unit. For example, the method in accordance with the invention can be used to realize a temporary communication link between individual terminals of a cellular trunked radio system.

I claim:

1. A method for prioritized processing of information that is transmitted in a wireless communication between centers and peripheral units of a traffic control system, whereby first information units are communicated from at least one central unit to the peripheral units, and communication between individual peripheral units may be established for second information units, comprising the steps of:
for communication between the individual peripheral units a second information unit of a peripheral unit is then processed as a priority if the above has previously received a key code transmitted with the first information unit and this corresponds to the key code contained in the second information unit.

2. The method in accordance with claim 1, wherein communication between individual peripheral units takes place on a different frequency than the frequency that is used for communication between at least one central unit and the peripheral units.

3. The method in accordance with claim 2, wherein communication between the individual peripheral units takes place in the infrared range.

4. The method in accordance with claim 1, wherein communication between the individual peripheral units takes place on the same frequency as is used for communication between at least one central unit and the peripheral units, but that the transmitter power for the communication between the individual peripheral units is reduced to such an extent that the range is limited to the immediate environment of a peripheral unit.

5. The method in accordance with claim 1, wherein the second information unit contains a further field that specifies the type of prioritized processing.

6. The method in accordance claim 1, wherein the transmitted key code contains information that specifies the type of prioritized processing.

7. The method in accordance with one of claim 1 wherein after a prioritized processing has been completed, the key code in the relevant peripheral unit is expended.
